(19) United States
(12) Patent Application Publication
(10) Pub. No.: US 2020/0224763 A1
(43) Pub. Date: Jul. 16, 2020

(54) Vehicle Backing Up Safety System

(71) Applicants: Frazier Cunningham, III, Canton, MI (US); Cindita D. Cunningham, Canton, MI (US)

(72) Inventors: Frazier Cunningham, III, Canton, MI (US); Cindita D. Cunningham, Canton, MI (US)

(21) Appl. No.: 16/737,344

(22) Filed: Jan. 8, 2020

Related U.S. Application Data
(60) Provisional application No. 62/791,348, filed on Jan. 11, 2019.

(51) Int. Cl. F16H 61/18; F16H 61/22; F16H 63/34

(52) U.S. Cl. CPC F16H 61/18; F16H 61/22; G01S 13/931; F16H 2061/223; F16H 63/34

(57) ABSTRACT

A vehicle safety system for a vehicle includes a transmission and a shifter control configured to shift the transmission from one gear state to another gear state. The vehicle safety system includes at least one sensor configured to detect objects around the vehicle. The vehicle safety system includes a control module configured to diagnose a presence of an object behind the vehicle based on a signal received from the at least one sensor and to prevent the shifter control from shifting into a reverse gear state based on the diagnosed presence.

### CROSS-REFERENCE TO RELATED APPLICATION

This application claims priority to U.S. Provisional Patent Application No. 62/791,348, filed Jan. 11, 2019, which is incorporated herein in its entirety by reference.

### TECHNICAL FIELD

This disclosure is related to a vehicular safety control system and method, in particular, to a system that prevents a user from putting a vehicle into a reverse gear based upon perceived obstacles.

### BACKGROUND

The statements in this section merely provide background information related to the present disclosure. Accordingly, such statements are not intended to constitute an admission of prior art.

Vehicles can include a wide variety of sensors known in the art. Radar, LIDAR, ultrasonic sensors, camera devices and other similar technology is known for use in aiding vehicle drivers and for guiding autonomous vehicles.

Automatic braking systems are known in the art. One known automatic braking system applies vehicle brakes if a person or object is sensed to be behind the vehicle or if there's a determination that a collision is about to occur.

SUMMARY

One aspect of this disclosure is a vehicle safety system for a vehicle including a transmission and a shifter control configured to shift the transmission from one gear state to another gear state. The vehicle safety system includes at least one sensor configured to detect objects around the vehicle. The vehicle safety system includes a control module configured to diagnose a presence of an object behind the vehicle based on a signal received from the at least one sensor and to prevent the shifter control from shifting into a reverse gear state based on the diagnosed presence.

Another aspect of this disclosure is a method of preventing a shifter control of a vehicle from shifting into a reverse gear state based on a diagnosed presence of an object behind the vehicle, where the shifter control is configured to shift a transmission of the vehicle from one gear state to another gear state. The method includes receiving a signal from at least one sensor configured to detect objects around the vehicle indicating that an object is detected behind the vehicle. The method includes diagnosing a presence of an object behind the vehicle based on the signal from the at least one sensor. The method includes preventing the shifter control from shifting into the reverse gear state based on the diagnosed presence of the object behind the vehicle.

Another aspect of this disclosure is a processor including a memory. The processor is configured to execute instructions stored on the memory to receive a signal from at least one sensor configured to detect objects around a vehicle indicating that an object is detected behind the vehicle. The processor is configured to execute instructions stored on the memory to diagnose a presence of an object behind the vehicle based on the signal from the at least one sensor. The processor is configured to execute instructions stored on the memory to prevent a shifter control of the vehicle from shifting into a reverse gear state based on the diagnosed presence of the object behind the vehicle, wherein the shifter control is configured to shift a transmission of the vehicle from one gear state to another gear state.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 illustrates an exemplary vehicle operating the disclosed system, in accordance with the present disclosure.

FIG. 2 illustrates schematically an exemplary control system useful to implement the disclosed system, in accordance with the present disclosure.

### DETAILED DESCRIPTION

A vehicle safety system and method is disclosed to prevent a vehicle operator from moving a transmission (e.g., an automatic transmission, a manual transmission, or a continuously variable transmission) into a reverse gear if a person or object is detected behind the vehicle and/or is determined to cause a threat of collision.

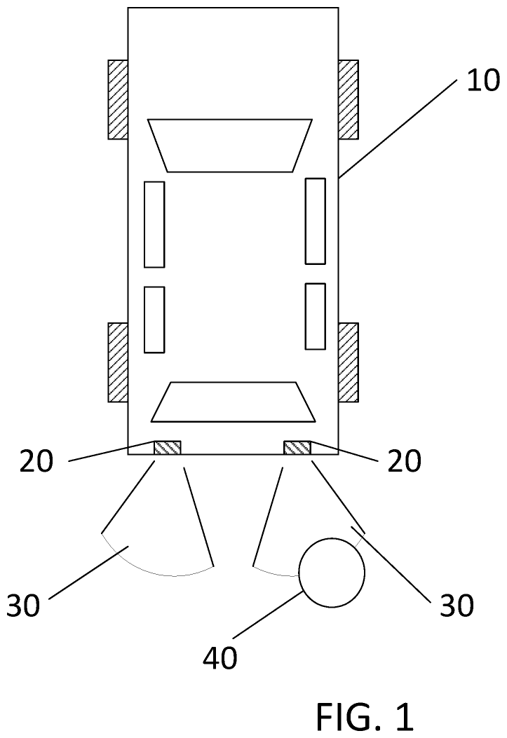

Referring now to the drawings, wherein the showings are for the purpose of illustrating certain exemplary embodiments only and not for the purpose of limiting the same, FIG. 1 illustrates an exemplary vehicle operating the disclosed system. Vehicle 10 is illustrated including one or more sensors 20 configured to observe the surroundings of vehicle 10. Sensors 20 can include fields of view 30, for example, representing a zone within which a camera or a similar device captures images. An onboard computing system can analyze the images according to methods known in the art and diagnose a presence of object 40 within one of the fields of view 30. The disclosed system, based upon this diagnosed presence, can intervene or lock a shifting mechanism (e.g., a shifter control) in the vehicle to prevent the vehicle from being shifted from a park setting to a reverse gear setting. The shifter control may include a lever arm, a shift dial, a touch screen, a button or switch, or any other device capable of receiving an input from the user indicating a desired transmission gear state (e.g., a drive or forward gear state, a park gear state, a neutral gear state, or a reverse gear state).

A number of embodiments of the locking system are envisioned. A mechanical lock can be used to lock the shifter control (e.g., a lever arm) in the vehicle cockpit into place, such that the lever arm cannot be moved. Similar locking mechanisms are known in the art, for example, in some vehicles stopping a similar move from park into reverse if the operator's foot is not on the brake pedal. In another example, the shifter control can be allowed to move or to select a gear state, but the system can electronically intervene, either disconnecting the shifter control from the transmission control devices of the vehicle transmission or by using electronic control of the transmission control devices to override the desired setting of the shifter control.

In one embodiment, the system can lock a shift from park into reverse until the object is cleared from the field of view. In another embodiment, an override button, switch, or other control can be used to permit the user to override the lock, for example, if snow, rain, or other debris is determined to be confusing the sensors of the vehicle and no object actually exists behind the vehicle.

In one embodiment, the system can prevent a move out of drive or neutral into reverse based upon the same diagnosed condition that something is behind the vehicle and moving into reverse would be unsafe. In one embodiment, in such a condition, the vehicle could stay in neutral or drive and automatic brakes could keep the vehicle stopped. In another embodiment, the system could cause the transmission to skip the reverse gear and transit directly from drive or neutral into park.

Visual sensors of any kind can be used to diagnose the disclosed condition causing the vehicle to lock in park. In another embodiment, audio sensors can be used to prevent the vehicle from going into reverse. Such audio sensors can trigger if, based upon volume of noises around the vehicle at different points, the source of the noise is behind the vehicle. In another embodiment, the noise can be analyzed, and if the noise is consistent with the voice of a child or pet, the system can prevent the shift.

In one embodiment, if the vehicle is already in reverse and is moving backward, the system, upon diagnosing the presence of an object, can automatically brake and automatically shift into park, then waiting for the obstacle to be cleared before permitting the shift.

The disclosed system is useful to prevent a driver from shifting into reverse in light of sensed obstacles around the vehicle. The system can additionally be useful if the vehicle is already in reverse. If the vehicle is in reverse, and a previously undetected obstacle is diagnosed, the system can command that the gear of the vehicle be shifted in neutral, that the transmission disengage regardless of the gear setting, that the throttle of the vehicle be cut to idle, and/or that automatic brakes be engaged.

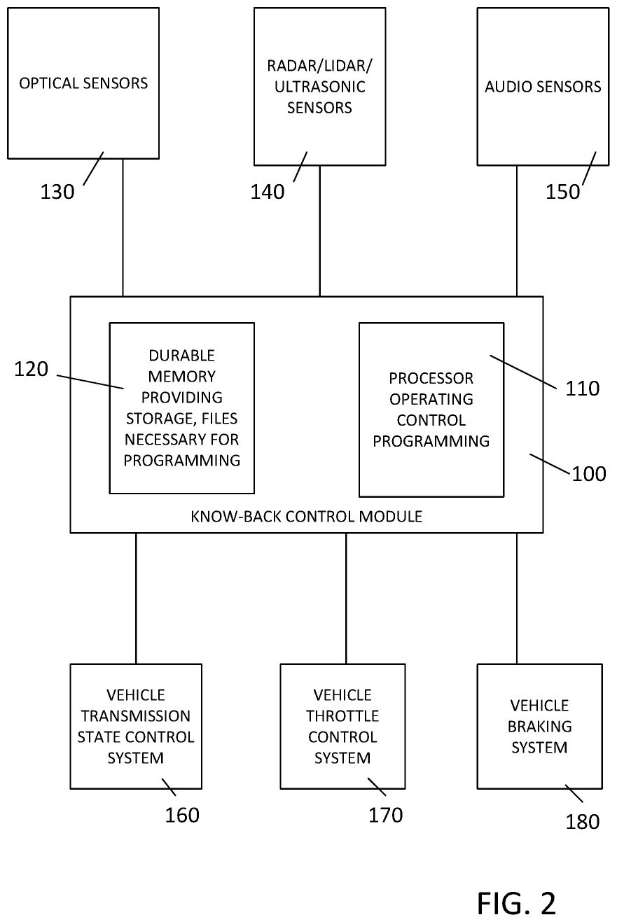

FIG. 2 illustrates schematically an exemplary control system useful to implement the disclosed system. Control module 100 is provided to include a computerized device or combination of computerized devices that can store and execute programmed functions. Control module 100 includes computerized processor 110 including RAM and is configured to operate programmed code. Control module 100 further includes durable memory storage in unit 120 and can include a hard drive or similar storage device. Control module 100 monitors inputs including but not limited to optical sensors 130, radar, LIDAR, or other sensors 140, and/or audio sensors 150. Control module 100 provides output or commands to vehicle control systems including but not limited to a vehicle transmission state control system 160, a vehicle throttle control system 170, and a vehicle braking system 180.

Implementations of the disclosed system, the exemplary control system, the control module 100, the computerized processor 110, the unit 120, the vehicle transmission state control system 160, the vehicle throttle control system 170, and the vehicle braking system 180 (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “controller” and “processor” should be understood as encompassing any of the foregoing hardware, either singly or in combination. The terms “signal” and “data” are used interchangeably. Further, portions of the disclosed system, the exemplary control system, the control module 100, the computerized processor 110, the unit 120, the vehicle transmission state control system 160, the vehicle throttle control system 170, and the vehicle braking system 180 do not necessarily have to be implemented in the same manner.

Further, in one aspect, for example, the disclosed system, the exemplary control system, the control module 100, the computerized processor 110, the unit 120, the vehicle transmission state control system 160, the vehicle throttle control system 170, and the vehicle braking system 180 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

While the invention has been described in connection with certain embodiments, it is to be understood that the invention is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law. One or more elements of the embodiments disclosed may be combined with one or more elements of any other embodiment disclosed.

What is claimed is:

1. A vehicle safety system for a vehicle including a transmission and a shifter control configured to shift the transmission from one gear state to another gear state, the vehicle safety system comprising:
at least one sensor configured to detect objects around the vehicle; and
a control module configured to:
diagnose a presence of an object behind the vehicle based on a signal received from the at least one sensor; and
prevent the shifter control from shifting into a reverse gear state based on the diagnosed presence.

2. The vehicle safety system of claim 1, wherein the control module is configured to send a signal to the shifter control causing the shifter control to mechanically lock based on the diagnosed presence.

3. The vehicle safety system of claim 1, wherein the control module is configured send a signal to electronically disconnect the shifter control from the transmission based on the diagnosed presence.

4. The vehicle safety system of claim 1, wherein the at least one sensor includes at least one of a camera device, a radar sensor, a LIDAR sensor, an ultrasonic sensor, or an audio sensor.

5. A method of preventing a shifter control of a vehicle from shifting into a reverse gear state based on a diagnosed presence of an object behind the vehicle, wherein the shifter control is configured to shift a transmission of the vehicle from one gear state to another gear state, the method comprising:
receiving a signal from at least one sensor configured to detect objects around the vehicle indicating that an object is detected behind the vehicle;
diagnosing a presence of an object behind the vehicle based on the signal from the at least one sensor; and
preventing the shifter control from shifting into the reverse gear state based on the diagnosed presence of the object behind the vehicle.

6. The method of claim 5, comprising sending a signal to the shifter control causing the shifter control to mechanically lock based on the diagnosed presence.

7. The method of claim 5, comprising sending a signal to electronically disconnect the shifter control from the transmission based on the diagnosed presence.

8. The method of claim 5, wherein the at least one sensor includes at least one of a camera device, a radar sensor, a LIDAR sensor, an ultrasonic sensor, or an audio sensor.

9. A processor including a memory, wherein the processor is configured to execute instructions stored on the memory to:
receive a signal from at least one sensor configured to detect objects around a vehicle indicating that an object is detected behind the vehicle;
diagnose a presence of an object behind the vehicle based on the signal from the at least one sensor; and
prevent a shifter control of the vehicle from shifting into a reverse gear state based on the diagnosed presence of the object behind the vehicle, wherein the shifter control is configured to shift a transmission of the vehicle from one gear state to another gear state.

10. The processor of claim 9, wherein the processor is configured to execute instructions stored on the memory to send a signal to the shifter control causing the shifter control to mechanically lock based on the diagnosed presence.

11. The processor of claim 9, wherein the processor is configured to execute instructions stored on the memory to send a signal to electronically disconnect the shifter control from the transmission based on the diagnosed presence.

12. The processor of claim 9, wherein the at least one sensor includes at least one of a camera device, a radar sensor, a LIDAR sensor, an ultrasonic sensor, or an audio sensor.
